(19) United States
(12) Patent Application Publication
(10) Pub. No.: US 2002/0087386 A1
(43) Pub. Date: Jul. 4, 2002

(54) Decision support system accessible via a communications network

(76) Inventor: Michael Allen Phillips, Chantilly, VA (US)

Correspondence Address: LAW OFFICE OF BARRY R LIPSITZ, 755 MAIN STREET, MONROE, CT, 06468, US

(21) Appl. No.: 09/751,220

(22) Filed: Dec. 28, 2000

(51) Int. Cl. G06F 17/60

(52) U.S. Cl. 705/10

(57) ABSTRACT

The present invention relates to a decision support system which is accessible via a communications network. In particular, the present invention provides integrated information, software applications, and communications capabilities which enable a user to quickly and easily make decisions. The invention further provides analytical decision assistant software applications which provide decision making assistance to the user. The decision support system of the present invention is particularly applicable to the field of marketing.

### BACKGROUND OF THE INVENTION

The present invention relates to a decision support system which is accessible via a communications network. In particular, the present invention provides integrated information, software applications, and communications capabilities which enable a user to quickly and easily make decisions. The invention further provides analytical decision assistant software applications which provide decision making assistance to the user. The decision support system of the present invention is described herein in connection with the field of marketing, although it is also useful for virtually any other application where decision support is desired, including the fields of business, medicine, law, accounting, engineering, manufacturing, education, sales and the like.

Marketers, for example, are under tremendous pressure to use the tools and information that have become widely available to be more effective and accountable. At a very basic level, this means using human, technology, information and economic resources more effectively. In other words, it is imperative that marketers seek to improve the return on their investment in these resources.

While information used in a marketer's decision making process is widely available, it is provided by multiple sources (some reliable; some not) and is subject to frequent change. The immediate challenge is not to get more information, it is to get the right information at the right time, to act on that information, to refine the information based on the results of an action and to share this information across the organization to create learning and common knowledge.

There is also no shortage of stand alone planning, implementation and analysis tools to make marketers more productive and accountable. However, most of these tools require substantial investment, not only in the tools themselves, but in the technical development and integration, training and ongoing support necessary to make best use of these tools.

Furthermore, it is not enough to merely have the information and tools. Increasingly, marketers are pressured to be on the same “marketing wavelength” relative to customers, markets, products and competitors to develop coherent marketing strategies and programs that all move effectively toward a common objective. Marketers are also constantly tested to be “experts” when, given the factors discussed above, this is almost impossible to accomplish anymore. As a result, marketers seek out experts. This is often an expensive and risky proposition. Marketers are uncomfortable with the amount of money and trust placed with experts, but feel there is no alternative to ensure marketing effectiveness.

Marketers face the same general decision challenges regardless of their industry. They all must make critical decisions using available information and tools within several key areas. These key areas, which are termed “decision domains” herein, must be considered by all marketers to be effective. Such decision domains include Customer/Segment, Brand, Product/Service, Channel, Pricing, Communications/Promotion. Within each of these domains, marketers must make a range of decisions to ensure effective marketing performance.

It would be advantageous to provide a decision support system via a communications network (e.g., the Internet) which provides marketing knowledge, decision-support software applications and collaboration tools in an integrated fashion for each decision domain. It would be further advantageous to provide community-building facilities to marketers via the communications network.

It would be even further advantageous to provide selected decision support software applications to a user on a subscription basis. It would also be advantageous if such software applications were specific to a particular decision domain, although this is not required by the invention. It would be further advantageous to provide domain-specific information which supports the decision-support applications for each decision domain.

It would be still further advantageous to provide only applications which are supplied by “best-of-breed” partners and are offered to marketers for a fee or on a subscription basis. Offering “best-of-breed” applications on a subscription basis provides substantial benefits as follows:

1. Marketers subscribe only for the applications they truly need; there is no need to “over-invest” in a suite of applications, of which the marketer would only use one or two;

2. There is no need to go through a long cycle of evaluation, selection, technical development and integration of the application since it is part of the decision support system; and

3. Applications are universally available across the organization, not concentrated in one or two specialized groups.

The methods and apparatus of the present invention provide the foregoing and other advantages.

### SUMMARY OF THE INVENTION

The present invention relates to a decision support system which is accessible via a communications network. In particular, the present invention provides integrated information, software applications, and communications capabilities which enable a user to quickly and easily make decisions. The invention further provides analytical decision assistant software applications which provide decision making assistance to the user. The decision support system of the present invention is particularly applicable to the field of marketing.

Although the invention is described in connection with decision support for the marketing field, those skilled in the art will appreciate that the invention can be implemented to provide decision support for virtually any field or industry, for example, manufacturing, health care, legal, education, finance, consulting, sales, and the like.

In an illustrative embodiment of the invention, decision support may be provided via a communications network. At least one client device may be provided which has access to the network. The client device may be a computer, a telephone, a personal digital assistant, an Internet appliance, or the like. A transaction server may be provided which is in communication with the client device via the network. A user interface to a computerized decision support system may be provided by the transaction server and accessible via the client device. For example, the user interface may comprise a web site with multiple pages, a web page, or other suitable computerized interfaces. The decision support system may consist of several portions. A library portion of said decision support system containing information relating to at least one decision domain may be provided. A workspace portion of said decision support system containing at least one software application may be provided. In addition, a conference function of the decision support system for enabling communications with others may also be provided. The user interface may allow selective access to one or more of the library portion, the workspace portion, and the conference function in order to facilitate making a decision.

In a further embodiment of the invention, a decision assistant portion of the decision support system containing at least one analytical software application may be provided. The decision assistant portion may provide at least one of marketing planning tools, campaign management tools, customer profiling tools, media planning tools, marketing analysis tools, collaboration tools, and the like. The decision assistant portion may also provide feedback from other users or experts. The analytical software applications available through the decision assistant portion may be provided by an application service provider (ASP). These applications may be licensed (e.g., from a system operator or the ASP).

The library portion of the decision support system may comprise a searchable database. The library portion may contain integrated information from multiple sources. In addition, the library portion may provide a check out function enabling the downloading or viewing of documents. The documents may include at least one of research studies, statistical compilations, treatises, strategic advice, analysis results, and the like. The library may provide at least one of a searching function, links to topically related web sites, notification of new library documents, monitoring and notification of changes in library information, integration of existing library documents, and the like. The library information may be updated periodically.

The conference function may provide at least one of web broadcasting, decision support demonstrations, expert support help, focus group feedback, chat facilities, threaded discussions, and the like. The conference function may make experts and professionals available to a user. The conference function may provide communications with others (e.g., experts, professionals, colleagues, co-workers, clients, and the like) on a real-time basis.

The workspace portion may be a web-based workspace. The workspace may provide at least one of document creation applications, project management applications, collaboration applications, scheduling applications, email applications, customer profiling applications, brand equity analysis applications, and fact based applications, as well as other types of applications.

In a further embodiment of the invention, the at least one decision domain may relate to marketing. The decision domains may relate to the marketing industry or to marketing professionals across various industries. The at least one decision domain may include at least one of a customer domain, a segment domain, a brand domain, a product domain, a service domain, a trade channel domain, a pricing domain, a communications domain, and a promotion domain. The library may include information relating to at least one of customer behavior, consumer trends, industry trends, competitors, pricing, promotions, products, services, brands, trade channels, and the like.

The communications network may comprise at least one of a global communications network, the world wide web, a wide area network, a local area network, the Internet, or any other type of network. The network may consist of multiple interconnected networks having multiple gateways and other features as is well known in the art. The decision support system may be provided in the form of a searchable web site.

Access to the decision support system, or any portion thereof, may be provided for a fee. For example, users may be charged on a per use basis, per period (e.g., monthly or yearly), number of applications used, number of portions accessed, time per use (e.g., number of minutes on system), and the like. Access may be based on a subscription fee. The subscription fee may be based on how many applications are selected.

The library, the workspace, and the conference function may all be associated with the at least one decision domain.

Access to news feeds may be provided relating to the at least one decision domain.

### BRIEF DESCRIPTION OF THE DRAWINGS

FIG. 1 shows a block diagram representation of the present invention; and

FIG. 2 shows a block diagram representation of exemplary decision domains which can be provided by the present invention.

### DETAILED DESCRIPTION OF THE INVENTION

The present invention provides an integrated marketing decision support and knowledge environment designed to deliver marketing knowledge, decision-support applications, collaboration tools and community-building facilities to users via a communications network. From the following detailed description, those skilled in the art will appreciate that the system provided for by the present invention comprises an evolving environment. Therefore, the description of the embodiments provided below are presented for purposes of example only. The invention may have many additional embodiments, permutations, adaptations, and applications other than those described below.

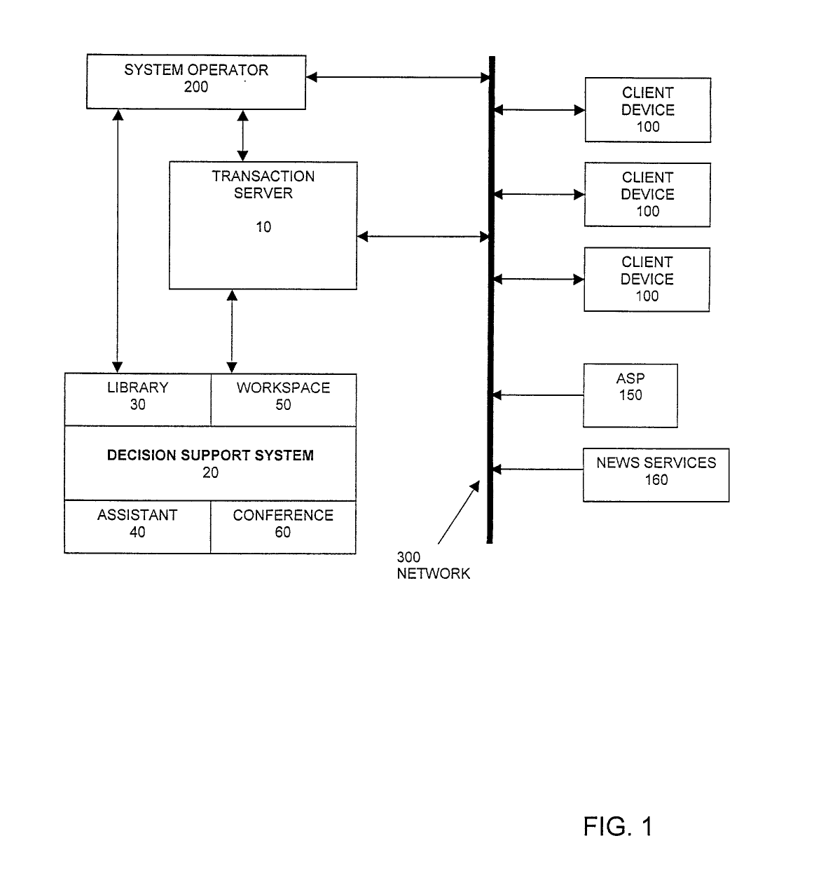

In an illustrative embodiment of the invention as shown in FIG. 1, decision support may be provided via a communications network 300. At least one client device 100 may be provided which has access to the network 300. The client device 100 may be a computer, a telephone, a personal digital assistant, an Internet appliance, or the like. A transaction server 10 may be provided which is in communication with the client device 100 via the network 300. A user interface to a computerized decision support system 20 may be provided by the transaction server 10 and accessible via the client device 100. For example, the user interface may comprise a web site with multiple pages, a web page, or other suitable computerized interfaces.

The decision support system 20 may consist of several portions. A library portion 30 of said decision support system 20 containing information relating to at least one decision domain may be provided. A workspace portion 50 of said decision support system 20 containing at least one software application may be provided. In addition, a conference function 60 of the decision support system 20 for enabling communications with others may be provided. The user interface may allow selective access (via the client device 100 and transaction server 10) to one or more of the library portion 30, the workspace portion 50, and the conference function 60 in order to facilitate making a decision.

In a further embodiment of the invention, a decision assistant portion 40 of the decision support system 20 containing at least one analytical software application may be provided. The decision assistant portion 40 may provide at least one of marketing planning tools, campaign management tools, customer profiling tools, media planning tools, marketing analysis tools, collaboration tools, and the like. The decision assistant portion 40 may also provide feedback from other users or experts. The analytical software applications available through the decision assistant portion 40 may be provided by an application service provider (ASP) 150. These applications may be licensed (e.g., from the system operator 200 or the ASP 150).

The library portion 30 of the decision support system 20 may comprise a searchable database. The library portion 30 may contain integrated information from multiple sources. In addition, the library portion 30 may provide a check out function enabling the downloading or viewing of documents. The documents may include at least one of research studies, statistical compilations, treatises, strategic advice, analysis results, and the like. The library 30 may provide at least one of a searching function (for example by subject area, keyword or key phrase), links to topically related web sites, notification of new library documents, monitoring and notification of changes in library information, integration of existing library documents, and the like. The library information may be updated periodically (e.g., by the system operator 200).

The conference function 60 may provide at least one of web broadcasting, decision support demonstrations, expert support help, focus group feedback, chat facilities, threaded discussions, and the like. The conference function 60 may make experts and professionals available to a user. The conference function 60 may also provide communications with others (e.g., experts, professionals, colleagues, coworkers, clients, and the like) on a real-time basis. Chat discussions may be recorded, stored and re-played via the conference function 60. The conference function 60 may also provide demonstration of decision support applications by experts. Questions for experts and support personnel may be submitted via the conference function 60. On-line focus groups may be conducted via the conference function 60 to provide immediate feedback from users.

The workspace portion 50 may be a web-based workspace. The workspace 50 may provide at least one of document creation applications, project management applications, collaboration applications, scheduling applications, email applications, customer profiling applications, brand equity analysis applications, and fact based applications, as well as other types of applications. The workspace portion 50 enables users (e.g., marketers within a client organization) to communicate with others on the results of their work as well as to make more meaningful (e.g., timely and appropriate) contributions to projects (such as marketing projects). For example, the workspace 50 may enable users to share work results with others via group and public workspaces; offer personal and team calendars for group scheduling; synchronize calendar information with personal digital assistants (PDAs) and popular desktop calendar tools; provide email or other notification of document changes or other events; and provide for meeting creation and notification.

The workspace portion 50 may enable a user to retrieve information; to retrieve and index data from the library portion 30; to create, edit, organize, and store work results; to re-use saved queries and search templates; and to display document summaries. Project management functions offered by the workspace portion 50 may include the ability to create tasks and edit task lists; create, edit, and delete workflow queries; attach objects (any type of documents) to the workflow package; and provide workflow status data, including graphical displays.

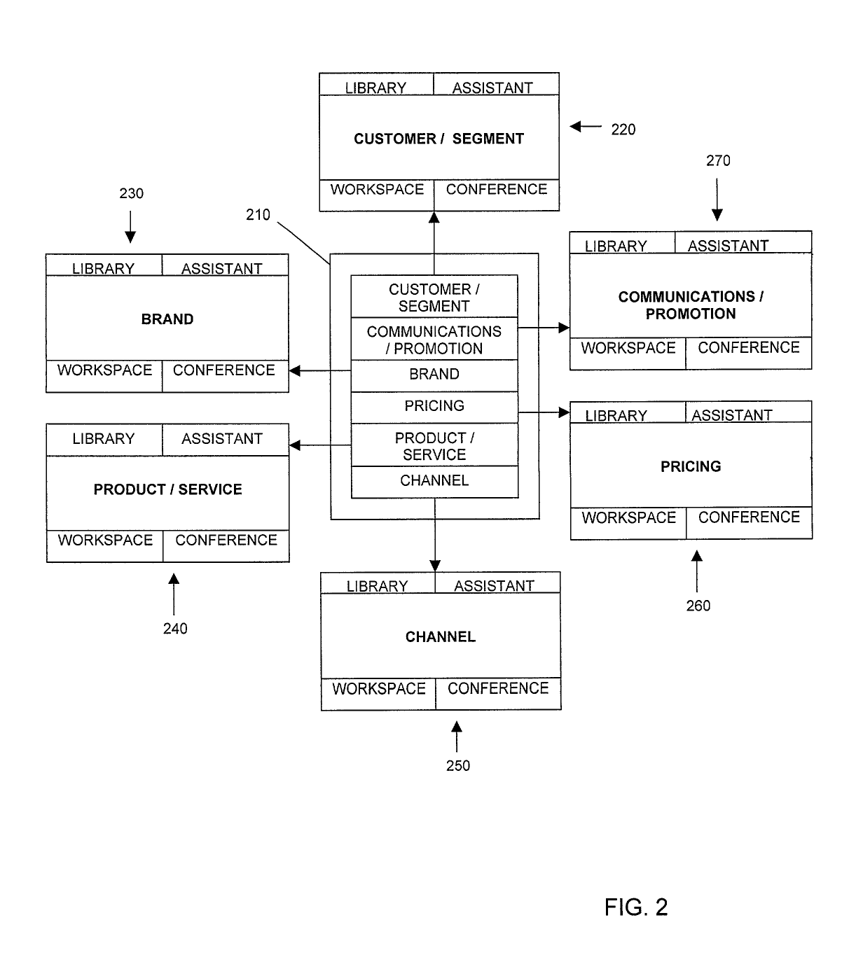

In a further embodiment of the invention as shown in FIG. 2, the decision support system may include at least one decision domain 210 relating, e.g., to marketing. In such an implementation, the decision domains may relate to the marketing industry generally or to marketing professionals across various industries. The decision domains 210 may include at least one of a customer/segment domain 220, a brand domain 230, a product/service domain 240, a trade channel domain 250, a pricing domain 260, and a communications/promotion domain 270. The customer/segment, product/service, and communications/promotion domains (220, 240, and 270) may be separated respectively into two distinct domains each. These six decision domains 210 are generally common to all marketers. Within each of these domains, marketers must make a range of decisions to ensure effective marketing performance. The present invention makes such applications and information available to marketers as they need it via a communications network (such as the world wide web) without the need for marketers to invest in a substantial application and information support infrastructure. Those skilled in the art will appreciate that the present invention is not limited to the six specific decision domains discussed herein. Other decision domains may be provided in connection with the invention depending upon the particular industry the system is tailored to, the needs of that particular industry, the needs of a particular company, or the like. The library 30, the assistant 40, the workspace 50, and the conference function 60, may all be associated with each decision domain 210.

Referring to FIG. 2, each decision domain 210 may have one or more particular applications associated therewith. For example, the customer/segment domain 220 may include applications relating to customer profiling and analysis, “customer empowerment” audits, opportunity analysis, valuable/vulnerable analysis, and the like. The brand domain 230 may include applications relating to consumer motivation, brand IQ diagnostics, focus group analysis, and the like. The product/service domain 240 may include applications relating to new product sales forecasting, new product positioning, product portfolio analysis, and the like. The trade channel domain 250 may include applications relating to channel performance analysis, on-line marketing mix model, sales force planning and evaluation, and the like. The pricing domain 260 may include applications relating to strategic pricing analysis, trade-off analysis, price elasticity, and the like. The communications/promotion domain 270 may include applications relating to web site profiling, marketing program design/management, marketing program performance analysis, and the like.

The library provided for each domain may include information relating to at least one of customer behavior, consumer trends, industry trends, competitors, pricing, promotions, products, services, brands, trade channels, and the like. Moreover, each library may include information from multiple sources (e.g., external providers, news services 160, system operator 200 and clients 100) integrated to create a common base of knowledge on a number of areas of interest to marketers (such as customer behavior, consumer/industry trends, competitors, and the like).

The communications network 300 which couples the various components as illustrated in FIG. 1 may comprise at least one of a global communications network (e.g., the Internet), the world wide web, a wide area network, a local area network, or any other type of network. The network may consist of multiple interconnected networks having multiple gateways and other features as is well known in the art. The decision support system 20 may be provided in the form of a searchable web site.

Access to the decision support system 20, or any portion 30, 40, 50, or 60 thereof (or combination of portions), may be provided for a fee. The fee may be charged on a subscription basis. The subscription fee may be based on how many applications are selected. In addition, users may be charged a fee on a per use basis, per period (e.g., monthly or yearly), number of applications used, number of portions accessed, time per use (e.g., number of minutes on system), and the like.

The decision support system 20 may provide access to news feeds relating to the at least one decision domain. The news feeds may be provided by the system operator 200 or directly by a news service 160.

The system operator 200 may control access to the decision support system 20. The system operator 200 may provide functions such as setting up of a new customer account enabling a customer to access the decision support system 20, the modification of an existing customer account, activation or de-activation of a customer account, provision of customer passwords to the decision support system 20, provision of technical assistance and training to customers (e.g., via the interface, the telephone, in person, through seminars, videotaped demonstrations, training software, via the conference function 60, and the like). The customer (user) may be a corporate or individual customer. The system operator 200 may modify or update the interface and the information contained in the library 30. The system operator may also add or remove applications provided by the decision support system 20. In addition, the system operator may add, remove, or modify the decision domains 210 provided by the decision support system 20.

It will now be appreciated that the present invention provides an improved decision support system which includes integrated information, software applications, and/or communications capabilities to enable a user to quickly and easily make decisions.

Although the invention has been described in connection with preferred embodiments thereof, those skilled in the art will appreciate that numerous adaptations and modifications may be made thereto without departing from the scope of the invention, as set forth in the claims.

What is claimed is:

1. A method for providing decision support via a communications network, comprising the steps of:
providing a user interface to a computerized decision support system via said communications network;
providing access via said interface to a library portion of said decision support system containing information relating to at least one decision domain;
providing access via said interface to a workspace portion of said decision support system containing at least one software application; and
providing access via said interface to a conference function of said decision support system for enabling communications with others;
wherein the user interface allows selective access to one or more of said library portion, workspace portion, and conference function in order to facilitate making a decision.

2. A method in accordance with claim 1, further comprising the step of providing access via said interface to a decision assistant portion of said decision support system containing at least one analytical software application.

3. A method in accordance with claim 2, wherein the decision assistant portion provides at least one of marketing planning tools, campaign management tools, customer profiling tools, media planning tools, marketing analysis tools, and collaboration tools.

4. A method in accordance with claim 2, wherein feedback from other users or experts can be provided through the decision assistant portion.

5. A method in accordance with claim 2, wherein the applications are provided by an application service provider.

6. A method in accordance with claim 5, further providing the step of licensing the analytical software applications.

7. A method in accordance with claim 1, wherein the library portion comprises a searchable database.

8. A method in accordance with claim 1, wherein the library portion contains integrated information from multiple sources.

9. A method in accordance with claim 1, wherein the library provides a check out function enabling the downloading or viewing of documents.

10. A method in accordance with claim 9, wherein the documents include at least one of research studies, statistical compilations, treatises, strategic advice, and analysis results.

11. A method in accordance with claim 1, wherein the library provides at least one of a searching function, links to topically related web sites, notification of new library documents, monitoring and notification of changes in library information, and integration of existing library documents.

12. A method in accordance with claim 1, wherein the conference function provides at least one of web broadcasting, decision support demonstrations, expert support help, focus group feedback, chat facilities, and threaded discussions.

13. A method in accordance with claim 1, wherein the conference function makes experts and professionals available to a user.

14. A method in accordance with claim 1, wherein the workspace is a web based workspace.

15. A method in accordance with claim 1, wherein the workspace provides at least one of document creation applications, project management applications, collaboration applications, scheduling applications, email applications, customer profiling applications, brand equity analysis applications, and fact based applications.

16. A method in accordance with claim 1, wherein the at least one decision domain relates to marketing.

17. A method in accordance with claim 16, wherein the at least one decision domain includes at least one of a customer domain, a segment domain, a brand domain, a product domain, a service domain, a trade channel domain, a pricing domain, a communications domain, and a promotion domain.

18. A method in accordance with claim 16, wherein the library includes information relating to at least one of customer behavior, consumer trends, industry trends, competitors, pricing, promotions, products, services, brands, and trade channels.

19. A method in accordance with claim 1, wherein the communications network comprises at least one of a global communications network, the world wide web, a wide area network, a local area network, and the Internet.

20. A method in accordance with claim 1, wherein access to the decision support system is provided for a fee.

21. A method in accordance with claim 1, wherein access is provided on a subscription fee basis.

22. A method in accordance with claim 21, wherein the fee is based on how many applications are selected.

23. A method in accordance with claim 1, wherein the decision support system is provided in the form of a searchable web site.

24. A method in accordance with claim 1, wherein the library, the workspace, and the conference function are all associated with the at least one decision domain.

25. A method in accordance with claim 1, wherein the conference function provides communications with others on a real-time basis.

26. A method in accordance with claim 1, comprising the further step of updating the library information.

27. A method in accordance with claim 1, comprising the further step of providing news feeds relating to the at least one decision domain.

28. Apparatus for providing decision support via a communications network, comprising:
at least one client device having access to the network;
a transaction server in communication with the client device via the network;
a user interface to a computerized decision support system provided by the transaction server and accessible via the client device;
a library portion of said decision support system containing information relating to at least one decision domain;
a workspace portion of said decision support system containing at least one software application; and
a conference function of said decision support system for enabling communications with others;
wherein the user interface allows selective access to one or more of said library portion, said workspace portion, and said conference function in order to facilitate making a decision.

29. Apparatus in accordance with claim 28, further comprising a decision assistant portion of said decision support system containing at least one analytical software application.

30. Apparatus in accordance with claim 29, wherein the decision assistant portion provides at least one of marketing planning tools, campaign management tools, customer profiling tools, media planning tools, marketing analysis tools, and collaboration tools.

31. Apparatus in accordance with claim 29, wherein feedback from other users or experts can be provided through the decision assistant portion.

32. Apparatus in accordance with claim 29, wherein the applications are provided by an application service provider.

33. Apparatus in accordance with claim 32, wherein the analytical software applications are licensed.

34. Apparatus in accordance with claim 28, where the library portion comprises a searchable database.

35. Apparatus in accordance with claim 28, wherein the library portion contains integrated information from multiple sources.

36. Apparatus in accordance with claim 28, wherein the library provides a check out function enabling the downloading or viewing of documents.

37. Apparatus in accordance with claim 36, wherein the documents include at least one of research studies, statistical compilations, treatises, strategic advice, and analysis results.

38. Apparatus in accordance with claim 28, wherein the library provides at least one of a searching function, links to topically related web sites, notification of new library documents, monitoring and notification of changes in library information, and integration of existing library documents.

39. Apparatus in accordance with claim 28, wherein the conference function provides at least one of web broadcasting, decision support demonstrations, expert support help, focus group feedback, chat facilities, and threaded discussions.

40. Apparatus in accordance with claim 28, wherein the conference function makes experts and professionals available to a user.

41. Apparatus in accordance with claim 28, wherein the workspace is a web based workspace.

42. Apparatus in accordance with claim 28, wherein the workspace provides at least one of document creation applications, project management applications, collaboration applications, scheduling applications, email applications, customer profiling applications, brand equity analysis applications, and fact based applications.

43. Apparatus in accordance with claim 28, wherein the at least one decision domain relates to marketing.

44. Apparatus in accordance with claim 43, wherein the at least one decision domain includes at least one of a customer domain, a segment domain, a brand domain, a product domain, a service domain, a trade channel domain, a pricing domain, a communications domain, and a promotion domain.

45. Apparatus in accordance with claim 43, wherein the library includes information relating to at least one of customer behavior, consumer trends, industry trends, competitors, pricing, promotions, products, services, brands, and trade channels.

46. Apparatus in accordance with claim 28, wherein the communications network comprises at least one of a global communications network, the world wide web, a wide area network, a local area network, and the Internet.

47. Apparatus in accordance with claim 28, wherein access to the decision support system is provided for a fee.

48. Apparatus in accordance with claim 28, wherein access is provided on a subscription fee basis.

49. Apparatus in accordance with claim 48, wherein the fee is based on how many applications are selected.

50. Apparatus in accordance with claim 28, wherein the decision support system is provided in the form of a searchable web site.

51. Apparatus in accordance with claim 28, wherein the library, the workspace, and the conference function are all associated with the at least one decision domain.

52. Apparatus in accordance with claim 28, wherein the conference function provides communications with others on a real-time basis.

53. Apparatus in accordance with claim 28, wherein the library information is updated periodically.

54. Apparatus in accordance with claim 28, further comprising access to news feeds relating to the at least one decision domain.
